(19) United States
(12) Patent Application Publication
(10) Pub. No.: US 2005/0279322 A1
(43) Pub. Date: Dec. 22, 2005

(54) Method and control unit for creating an injection pulse width

(76) Inventor: Andreas Kufferath, Besigheim (DE)

Correspondence Address: KENYON & KENYON, ONE BROADWAY, NEW YORK, NY, 10004, US

(21) Appl. No.: 10/980,138

(22) Filed: Nov. 1, 2004

(30) Foreign Application Priority Data
Nov. 15, 2003 (DE) 103 53 434.2

(51) Int. Cl. F02D 41/40

(52) U.S. Cl. 123/299; 123/435

(57) ABSTRACT

A method and a control unit are provided for creating an injection pulse width for dosing a predetermined fuel quantity out of a fuel accumulator via an injection valve into a combustion chamber of an internal combustion engine, taking into account a difference between a fuel pressure in the fuel accumulator and a combustion chamber pressure, the combustion chamber pressure being computationally modeled using laws of polytropic changes of state. The method provides that a dependence of a polytropic coefficient on at least one operating parameter of the internal combustion engine is taken into account in the computational modeling.

### FIELD OF THE INVENTION

The present invention relates to a method and a control unit for creating an injection pulse width for dosing a predetermined fuel quantity out of a fuel accumulator via an injection valve into a combustion chamber of an internal combustion engine, taking into account a difference between a fuel pressure in the fuel accumulator and a combustion chamber pressure, the combustion chamber pressure being computationally modeled using laws for polytropic changes of state.

### BACKGROUND INFORMATION

A method and a control unit for creating an injection pulse width are described in German Patent document DE 199 58 465. In direct fuel injection, fuel is injected by way of a high-pressure injection valve directly into the combustion chamber. The fuel quantity injected depends on the injection pulse width that is used, the flow rate parameter of the injection valve, and the fuel inlet pressure and combustion chamber pressure.

In German Patent document DE 199 58.465, the pressure differential between the fuel inlet pressure and combustion chamber pressure is employed to calculate the flow rate through the high-pressure injection valve; a calculation based only on fuel inlet pressure would result in incorrect calculations as combustion chamber pressure fluctuates. This is especially true for injections in the compression stroke, for which pressures in the combustion chamber exceeding 5 bar can certainly be present.

It is known in the art that internal combustion engines with direct fuel injection can be operated with homogeneous fuel distribution in the combustion chamber charge or with stratified fuel distribution in the combustion chamber charge. Homogeneous distribution is achieved using an early injection during the intake stroke, while stratified distribution is obtained by an injection during the compression stroke, occurring shortly before ignition of the combustion chamber charge. Homogeneous distribution occurs as a consequence of the greater interval prior to ignition, and the motion of the combustion chamber charge produced during subsequent compression. A stratified combustion chamber charge is combusted with an excess of air, which is obtained by largely unthrottled intake of air. The torque commanded by the driver is established substantially by way of the fuel quantity injected. With homogeneous combustion chamber charges, however, the torque is established substantially by way of the quantity of the entire combustion chamber charge, e.g., by throttling.

In experiments with known methods, discrepancies have still occurred between the injection quantity to be expected on the basis of the known calculation and the fuel quantity that is actually injected. Such discrepancies are undesirable because of their potentially disadvantageous effects. In stratified mode, for example, a discrepancy of this kind can result in an incorrect torque. In the homogeneous-split mode (fuel injection in homogeneous mode that is split between two individual injections), discrepancies affect the residual oxygen content in the exhaust gas, which can cause problems in exhaust gas post-treatment. The aforesaid discrepancies have been evident especially when internal combustion engines are being started.

Against this background, it is an object of the present invention to provide a method and a control unit for creating injection pulse widths with which the aforesaid disadvantages can be avoided or at least minimized.

### SUMMARY OF THE INVENTION

The above object is achieved in that a dependence of a polytropic coefficient on operating parameters of the internal combustion engine is taken into account in the computational modeling.

The present invention is based on the recognition that in many operating states, the premises for the previous pressure calculation represent too coarse an approximation.

The present invention utilizes the fact that the variable polytropic coefficient dependent on operating parameters of the internal combustion engine provides a substantial improvement that permits a much more accurate calculation of the internal combustion chamber pressure.

As a consequence of the improved calculation of the internal combustion chamber pressure, the calculated combustion chamber pressures for each operating point deviate less from the actual combustion chamber pressure. As a consequence, the calculated difference from the fuel inlet pressure, and thus ultimately the fuel quantity that is metered, deviates less from the target value. The aforementioned problems of the prior art are thereby significantly reduced.

In an example embodiment, it is provided that the combustion chamber pressure at the time of an injection be determined by multiplicative combination of:
a combustion chamber volume, raised to the power of a fixed polytropic coefficient, at the time at which a connection between the combustion chamber and the intake duct closes;
an associated value of the combustion chamber pressure;
a reciprocal of a combustion chamber volume at the time of the injection, raised to the power of the fixed polytropic coefficient; and
a correction factor.

In existing engine control programs, characteristic curves are used that are addressed with a crankshaft angle and supply a value that, after multiplication by an initial pressure, yields a combustion chamber pressure. The characteristic curve values therefore correspond to a quotient of combustion chamber volumes that have been multiplied by a fixed polytropic coefficient, for example, a fixed value of 1.32. Because a global correction factor is used in the aforesaid embodiment of the present invention, it is possible to dispense with complex expansion of the characteristic curves into characteristics diagrams, in which operating-parameter-dependent influences of changes in the polytropic coefficient are additionally mapped. As a result, both the effort for preparing such characteristics diagrams when designing a control unit program, and memory space requirements, are reduced. Existing program structures can continue to be used, with the change of an additional multiplication and determination of a global correction factor.

It may further be provided that a correction factor dependent on the rotation speed of the internal combustion engine be used.

It has been found that, in particular, a dependence of the polytropic coefficient on the rotation speed of the internal combustion engine results in large improvements. It is thereby possible, in particular, to take into account in correcting fashion the fact that the polytropic coefficient possesses a large slope at low rotation speeds. The consequence is that the injection pulse width is created in more accurately targeted fashion, e.g., when internal combustion engines are started.

It may also be provided that the correction factor be constituted such that it corresponds to a smaller polytropic coefficient at lower rotation speeds than at higher rotation speeds.

The result of this action is that incorrect adaptations of the injection volume at low rotation speeds, and thus especially when the internal combustion engine is being started, are largely avoided.

It may further be provided that a dependence of a polytropic coefficient on a temperature of the internal combustion engine be taken into account as an operating parameter in the computational modeling.

This feature compensates, with little computational cost, for additional temperature dependences such as those brought about by an energy exchange between the combustion chamber charge and the combustion chamber walls.

A further example embodiment provides that in an operating mode in which the internal combustion engine is being operated with several injections per combustion chamber and per working cycle, the dependence of a polytropic coefficient that is taken into account in creating a subsequent injection pulse width being reduced as compared with a polytropic coefficient that was used in creating a previous injection pulse width.

This embodiment takes into account, with little computational cost, the influence of the vaporization enthalpy of the injected fuel from the previous injection on the combustion chamber pressure at the time of the second injection.

It may also be provided that for an injection occurring after an intake stroke, a pressure in the intake duct of the internal combustion engine upon closing of an intake valve associated with the combustion chamber be used as the starting value for modeling the combustion chamber pressure.

It has been found that this feature also contributes to more accurate calculation of the injection quantity flowing through the injection valve.

It may also be provided that the combustion chamber pressure be created as the product of the starting value and a factor that is determined as the quotient, raised to the power of the polytropic coefficient, of the combustion chamber volume at the time the intake valve closes and the current volume, dependent on a further piston motion, of the combustion chamber.

This feature allows the calculation, known per se, of the internal combustion chamber pressure to be largely retained. In this embodiment, the advantageous effects of the invention result from appropriate selection of the variable polytropic coefficient. Existing program structures for calculating injection pulse widths can therefore be largely carried over.

It may also be provided that a polytropic coefficient dependent on an engine mileage of the internal combustion engine be used.

This feature allows the increasing quantity of so-called blow-by gases with increasing engine mileage to be taken into account. “Blow-by gases” are understood to be portions of the combustion chamber charge that flow past the piston to the crankcase and therefore exert no pressure-increasing effect in the combustion chamber. The blow-by gases thus diminish the gas volume that is effectively compressed, and thus result in a decreased combustion chamber pressure as compared with an ideally sealed combustion chamber. Consideration of this effect results in improved conformity between the target flow quantity through the injection valve and the actual flow quantity. Because this effect is dealt with not separately, by a reduction in gas volume when modeling the combustion chamber pressure, but instead as a change in the polytropic coefficient, the effect can be taken into account in the same program structures as a change in the polytropic coefficient. The consequence is a decreased computational cost during operation of the internal combustion engine, and a decreased programming effort when designing control unit programs to control internal combustion engines.

### BRIEF DESCRIPTION OF THE DRAWINGS

FIG. 1 schematically shows an internal combustion engine with an injection system and control system.

FIG. 2 illustrates part of a first example embodiment of an engine control program according to the present invention.

FIG. 3 shows a chart of polytropic coefficient plotted against the rotation speed of the internal combustion engine.

FIG. 4 illustrates part of a second example embodiment of an engine control program according to the present invention.

### DETAILED DESCRIPTION

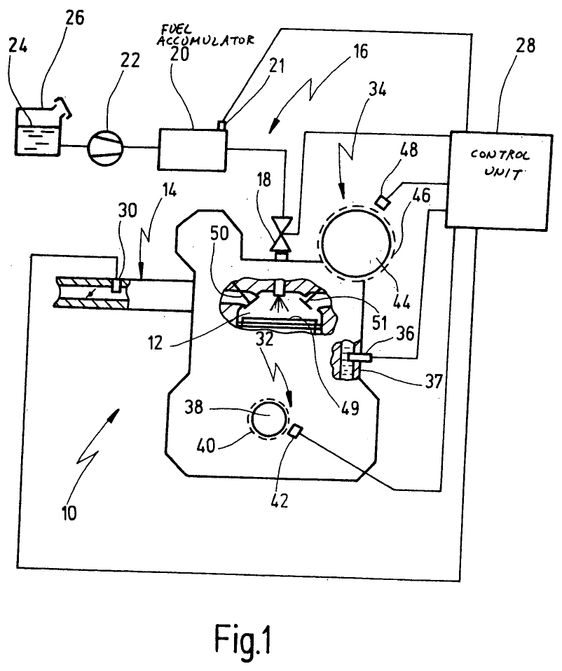

FIG. 1 shows an internal combustion engine 10 having at least one combustion chamber 12 which takes in air via an intake duct 14 and to which fuel is metered via an injection system 16. Injection system 16 has an injection valve 18, projecting into combustion chamber 12, that is supplied with fuel under injection pressure from a fuel accumulator 20. The injection pressure in fuel accumulator 20 is generated by a fuel pump 22 that draws fuel 24 out of a fuel tank 26. Fuel pump 22 is depicted in FIG. 1 as a single pump. It is understood, however, that fuel pump 22 can also be implemented as a combination of a low-pressure pump and a downstream high-pressure pump.

Internal combustion engine 10, and the metering of fuel to the at least one combustion chamber 12 occurring via injection valve 18, is controlled by a control unit 28. In order to perform its control tasks, control unit 28 has signals delivered to it from various sensors regarding operating parameters of internal combustion engine 10. In the case of internal combustion engine 10 shown in FIG. 1, these are a fuel pressure sensor 21, an intake duct pressure sensor 30, a crankshaft angle sensor 32, a camshaft sensor 34, and a temperature sensor 36 which is arranged in a cooling jacket 37 of internal combustion engine 10 and thus senses a variable representative of the temperature of internal combustion engine 10.

Crankshaft angle sensor 32 encompasses a first trigger wheel 38 which has first ferromagnetic marks 40 that are scanned by an inductive transducer 42. Camshaft sensor 34 similarly has a second trigger wheel 44 having ferromagnetic marks 46 that are scanned by an inductive transducer 48. Crankshaft angle sensor 32 allows determination of the position of a piston 49 which, as is known, defines the volume of combustion chamber 12 enclosed above piston 49. By way of the signal of camshaft sensor 34, the piston position is associated with a stroke of the internal combustion engine. Camshaft sensor 34 furthermore supplies information regarding the times at which an intake valve 50 of combustion chamber 12 and an exhaust valve 51 of combustion chamber 12 open or close.

From these and, if applicable, further signals of further sensors, control unit 28 creates, inter alia, a target value for the fuel quantity to be injected, and an injection pulse width with which injection valve 18 is opened in order to inject into combustion chamber 12 a fuel quantity corresponding to the target value. Since the fuel quantity actually injected depends on the pressure difference between the fuel pressure in fuel accumulator 20 and the pressure in combustion chamber 12, this pressure difference is taken into account in creating the injection pulse width. The pressure in combustion chamber 12 is modeled on the basis of signals of the sensors depicted. It is essential for modeling that a pressure in combustion chamber 12 at the time at which intake valve 50 closes is known. This pressure corresponds approximately to the pressure in intake duct 14 and can therefore be derived from the signal of intake duct sensor 30. An associated volume of combustion chamber 12 can be derived from the position of piston 49 and thus from signals of crankshaft angle sensor 32 and/or camshaft sensor 34. The rotation speed of internal combustion engine 10 can additionally be derived from the signal of crankshaft angle sensor 32 and/or camshaft sensor 34.

It is understood that these variables—i.e. the rotation speed, the volume of combustion chamber 12, and the intake duct pressure—can be derived not only from signals of the sensor depicted, but also from signals of other sensors. For example, instead of crankshaft angle sensor 32 and/or camshaft sensor 34 that operate, as depicted in FIG. 1, with inductive transducers 42 and 48, any other type of angle sensor can also be used. It is also possible, for example, to derive angles by the analysis of optical signals. The intake duct pressure can also, for example, be determined in modeled fashion from signals for the position of a throttle valve in intake duct 14 and/or the rotation speed of internal combustion engine 10 and/or the quantity of air taken in by internal combustion engine 10.

The basis used for calculation of the combustion chamber pressure is generally a polytropic change of state in the combustion chamber charge enclosed in combustion chamber 12. A state is characterized here by values for the pressure p, volume V, and temperature T of the combustion chamber charge. In theoretical considerations of changes of state, a distinction is made among isochoric, isobaric, isothermal, and adiabatic changes of state. Real changes of state in combustion chamber 12 of an internal combustion engine can be understood as mixed forms of adiabatic and isothermal changes of state. For purely adiabatic compression, the applicable equation is known to be:
p V^{K}=constant,
where the variable K refers to the adiabatic coefficient that represents the ratio between the specific heat capacity of the combustion chamber volume at constant pressure and the specific heat capacity of the combustion chamber charge at constant volume. An adiabatic compression is characterized in that no energy exchange occurs with the combustion chamber walls. For the engine compression process, this assumption is justified when the process takes place very quickly, which is the case to a first approximation, for example, at higher rotation speeds (>2000 rpm). At these rotation speeds, the time span for heat exchange with the combustion chamber walls is so short that the adiabatic approximation is justified.

The greater the heat exchange between the combustion chamber charge and combustion chamber walls during compression, the greater the departure from an adiabatic process. For the limiting case of an infinitely slow machine, in which combustion chamber 12 experiences complete heat exchange with the combustion chamber walls that possess a constant temperature level at the durations of individual piston strokes, the result is then an isothermal process. The equation governing an isothermal process is:
p V=constant.

The real engine process during compression lies between an adiabatic and an isothermal process. It can be described by the following equation:
p V^{X}=constant,
where X has a value between 1 and the value of K. Variable X is also referred to as a polytropic coefficient. When X=K the process is purely adiabatic, and when X=I it is a purely isothermal process. In the existing art described above initially, a combustion chamber pressure is determined based on the assumption of a constant polytropic coefficient X that is not dependent on operating parameters of internal combustion engine 10.

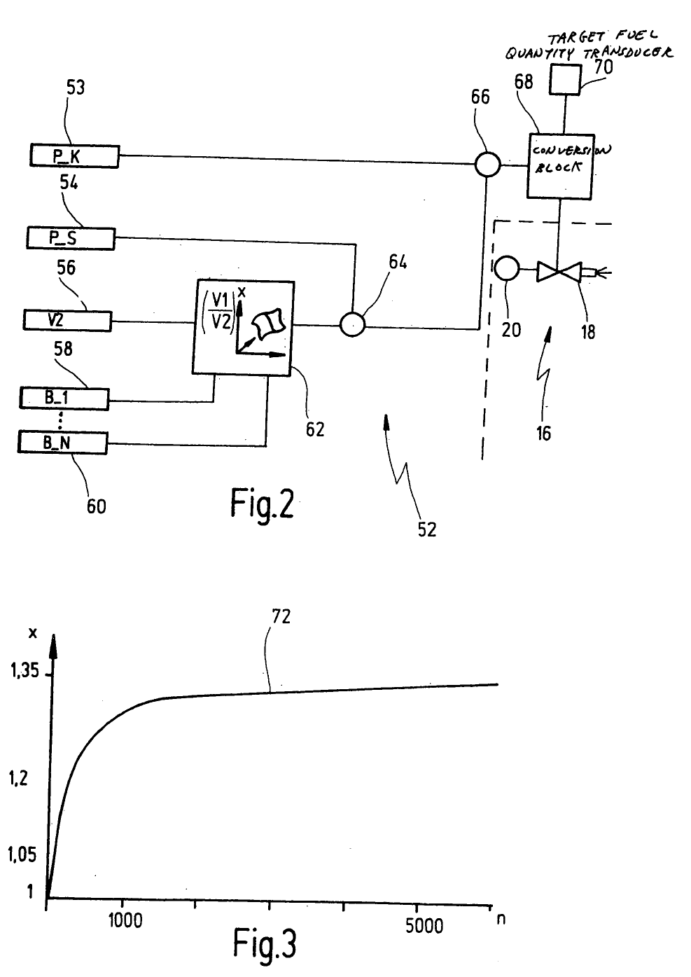

In the context of the present invention, the pressure difference at injection valve 18 used in the creation of an injection pulse width is one for whose determination a dependence of the polytropic coefficient on operating parameters of the internal combustion engine was taken into account. FIG. 2 depicts an example embodiment of a segment 52 of an engine control program in which an operating-parameter-dependent polytropic coefficient is used. Program segment 52 encompasses various input channels 53, 54, 56, 58, and 60 through which the input variables for calculation are delivered. A value for fuel pressure P_K, for example, is delivered via a first input channel 53. A value for intake duct pressure P_S is made available via a second input channel 54, and third input channel 56 supplies a value for a combustion chamber volume V2 that refers to a volume of combustion chamber 12 at the time of an injection of fuel.

Signals regarding operating parameters B_1 through B_N are also delivered to program segment 52. The value P_K, for example, is made available by fuel pressure sensor 21, while the value P_S can be supplied by intake duct pressure sensor 30. Volume V2 can be determined from information regarding the position of piston 49. It will be assumed hereinafter that B_1 corresponds to rotation speed n, and B_N to temperature T of internal combustion engine 10. It is understood, however, that these variables and, if applicable, further variables B_2 through B_N-1 can also, alternatively or additionally, represent other operating variables of internal combustion engine 10 that influence polytropic coefficient X, or the pressure in the volume of combustion chamber 12, or the volume of combustion chamber 12.

Examples of such operating variables are the intake air temperature, the number of injections per working cycle of a combustion chamber 12, and, if applicable, information regarding variable valve control times. In conventional gas exchange control systems, the times at which intake valve 50 closes are predefined and known in control unit 28. The time at which intake valve 50 closes is correlated with a specific position of piston 59, and therefore also with a specific volume V1 of combustion chamber 12. Upon subsequent compression, the volume of combustion chamber 12 is decreased to a volume V2. Volume V2 corresponds to the volume of combustion chamber 12 at which an injection of fuel via injection valve 18 takes place. The values for V2 and B_1 through B_N are used to address a characteristics diagram 62 in which values for the quotients, raised to the power of a polytropic exponent X, of volumes V1 and V2 are stored.

For a given volume ratio V1:V2, different polytropic coefficients X yield different values. By addressing characteristics diagram 62 in operating-parameter-dependent fashion, it is possible to take into account an operating parameter dependence of polytropic coefficient X when determining the output variable of characteristics diagram 62. The value read out from characteristics diagram 62 is multiplied, in a first operation 64, by the intake duct pressure P_S at the time at which intake valve 50 closes, i.e., at a combustion chamber volume V1. The result of the multiplication represents the modeled combustion chamber pressure in combustion chamber volume V2 at the time of injection.

This combustion chamber pressure is delivered to a second operation 66 in which it is subtracted from fuel pressure P_K. The result obtained after second operation 66 is the pressure difference across injection valve 18. This pressure difference is delivered to a conversion block 68 that also receives, from a target fuel quantity transducer 70, a signal regarding a target fuel quantity. Using a flow rate characteristic curve stored in conversion block 68, which indicates flow rate as a function of differential pressure, this target fuel quantity is converted into an injection pulse width with which injection valve 18 is activated in the opening direction. The conversion is accomplished in such a way that for a predetermined fuel quantity, a greater injection pulse width is created at a low differential pressure than at a higher differential pressure.

FIG. 3 shows, with the profile of curve 72, an operating parameter dependence of polytropic coefficient X for the example of engine rotation speed n. As already mentioned, for high rotation speeds this dependence approaches a limit value that corresponds to the exponent for an adiabatic change of state. It was also mentioned that the behavior of polytropic coefficient X for slow processes—in other words, taking the example of internal combustion engine 10, for low rotation speeds—approaches an isothermal process where X=1. As well as these correlations that have already been explained, FIG. 3 additionally shows the very steep profile at low rotation speeds below 1000 rpm, and the comparatively flat profile at rotation speeds above approximately 2000 rpm. It is precisely the steep slope in the range of low rotation speeds that is the cause of the problems cited initially. With the invention presented here, this dependence is taken into account, by modeling, in the calculation of the internal combustion chamber pressure, this dependence being incorporated into characteristics diagram 62 in the exemplifying embodiment of FIG. 2.

For other operating parameters, for example engine temperature, other correlations apply. In the case of engine temperature T, for example, it is the case that high engine temperatures bring about, as it were, an approximation to an adiabatic process, while at low engine temperatures a greater heat transfer takes place from the compressed combustion chamber charge to the cold combustion chamber walls, thus shifting the process profile away from the adiabatic limit case toward the isothermal limit case.

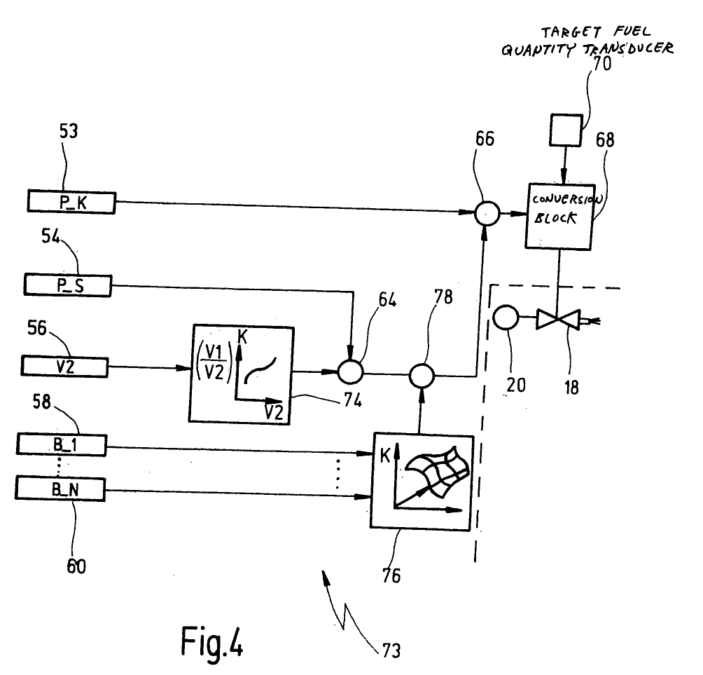

FIG. 4 shows a segment 73 of another example embodiment of an engine control program, as an alternative to segment 52 of FIG. 2. The subject matter of FIG. 4 differs from the subject matter of FIG. 2 firstly in that characteristics diagram block 62 of FIG. 2 has been replaced, in the subject matter of FIG. 4, with a characteristic curve block 74. Values of the quotient, raised to the power of a fixed polytropic coefficient X, of V1 and V2, plotted against characteristics diagram input variable V2, are stored in characteristic curve block 74 of FIG. 4. Multiplying the characteristics diagram output variable by the intake duct pressure P_S at volume V1 in the first operation yields a combustion chamber pressure that has also already been determined in the existing art using a fixed polytropic coefficient. In the subject matter of FIG. 4, an operating parameter dependence of polytropic coefficient X is taken into account by way of a further operation 78 in which the combustion chamber pressure value obtained with a fixed polytropic coefficient X is multiplied by a correction factor K.

Correction factor K is read out from a characteristics diagram 76 that is addressed as a function of operating parameters B_1 through B_N already explained in conjunction with FIG. 2, or a selection of those operating parameters. While the subject matter of FIG. 2 is notable in that it maps the physical correlations very accurately, the subject matter of FIG. 4 is notable for a simple implementation in which characteristic curve 74 in particular, and characteristics diagram 76 as well, need to be provided with little data. Correction is accomplished in third operation 78, for example in such a way that the combustion chamber pressure value made available by first operation 64 is made smaller at low rotation speeds if the characteristic curve in characteristic curve block 74 was obtained with a polytropic coefficient X at high rotation speeds.

1. A method for creating an injection pulse width for dosing a predetermined fuel quantity out of a fuel accumulator via an injection valve into a combustion chamber of an internal combustion engine, comprising:
determining a difference between a fuel pressure in the fuel accumulator and a combustion chamber pressure, wherein the combustion chamber pressure is computationally modeled using laws of polytropic changes of state; and
computing a polytropic coefficient from at least one operating parameter of the internal combustion engine.

2. The method as recited in claim 1, wherein the combustion chamber pressure at a time of an injection is determined by multiplicative combination of:
a combustion chamber volume, raised to the power of a fixed polytropic coefficient, at the time at which a connection between the combustion chamber and an intake duct closes;
an associated value of the combustion chamber pressure;
a reciprocal of a combustion chamber volume at the time of the injection, raised to the power of the fixed polytropic coefficient; and
a correction factor.

3. The method as recited in claim 2, wherein the correction factor depends on a rotation speed of the internal combustion engine.

4. The method as recited in claim 3, wherein the correction factor corresponds to a smaller polytropic coefficient at lower rotation speeds than at higher rotation speeds.

5. The method as recited in claim 1, wherein the at least one operating parameter of the internal combustion engine is a rotation speed of the internal combustion engine.

6. The method as recited in claim 5, wherein the polytropic coefficient is smaller at lower rotation speeds than at higher rotation speeds.

7. The method as recited in claim 1, wherein the at least one operating parameter of the internal combustion engine is a temperature of the internal combustion engine.

8. The method as recited in claim 1, wherein in an operating mode in which the internal combustion engine is being operated with several injections per combustion chamber and per working cycle, the dependence of a polytropic coefficient that is taken into account in creating a subsequent injection pulse width is reduced in comparison to a polytropic coefficient that was used in creating a previous injection pulse width.

9. The method as recited in claim 1, wherein the combustion chamber pressure at a time of an injection is computed as the product of a starting value of the combustion chamber pressure and a quotient, raised to the power of the polytropic coefficient, of a combustion chamber volume at the time an intake valve closes and a current volume, dependent on a further piston motion, of the combustion chamber.

10. The method as recited in claim 9, wherein for an injection occurring after an intake stroke, a pressure in an intake duct of the internal combustion engine upon closing of the intake valve is used as the starting value of the combustion chamber pressure.

11. The method as recited in claim 1, wherein the at least one operating parameter of the internal combustion engine is an engine mileage of the internal combustion engine.

12. A method for creating an injection pulse width for dosing a predetermined fuel quantity out of a fuel accumulator via an injection valve into a combustion chamber of an internal combustion engine, taking into account a difference between a fuel pressure in the fuel accumulator and a combustion chamber pressure, the combustion chamber pressure being computationally modeled using laws of polytropic changes of state, the method comprising:
computing the combustion chamber pressure at a time of an injection by multiplicative combination of:
a combustion chamber volume, raised to the power of a fixed polytropic coefficient, at the time at which a connection between the combustion chamber and an intake duct closes;
an associated value of the combustion chamber pressure;
a reciprocal of a combustion chamber volume at the time of the injection, raised to the power of the fixed polytropic coefficient; and
a correction factor accounting for a polytropic coefficient, the polytropic coefficient depending on at least one operating parameter of the internal combustion engine.

13. A control unit for creating an injection pulse width for dosing a predetermined fuel quantity out of a fuel accumulator via an injection valve into a combustion chamber of an internal combustion engine, comprising:
means for determining a difference between a fuel pressure in the fuel accumulator and a combustion chamber pressure, wherein the combustion chamber pressure is computationally modeled using laws of polytropic changes of state; and
means for computing a polytropic coefficient from at least one operating parameter of the internal combustion engine.

14. The control unit as recited in claim 13, wherein the at least one operating parameter of the internal combustion engine is a rotation speed of the internal combustion engine.

15. The control unit as recited in claim 13, wherein the at least one operating parameter of the internal combustion engine is a temperature of the internal combustion engine.

16. The control unit as recited in claim 13, wherein the at least one operating parameter of the internal combustion engine is an engine mileage of the internal combustion engine.
